(19) United States
(12) Patent Application Publication
(10) Pub. No.: US 2021/0150900 A1
(43) Pub. Date: May 20, 2021

(54) INFORMATION PRESENTING DEVICE, INFORMATION PRESENTING METHOD, AND MANNED DRIVING VEHICLE

(71) Applicant: Komatsu Ltd., Tokyo (JP)

(72) Inventors: Masanobu Seki, Tokyo (JP); Shunsuke Miyamoto, Tokyo (JP); Kaoru Yasuda, Tokyo (JP)

(21) Appl. No.: 16/768,902

(22) PCT Filed: Feb. 12, 2019
(86) PCT No.: PCT/JP2019/004847

§ 371 Date: Jun. 2, 2020

(30) Foreign Application Priority Data
Feb. 28, 2018 (JP) 2018-035242

(51) Int. Cl. G08G 1/0968; G01C 21/36; G01C 21/34; H04W 4/46

(52) U.S. Cl. CPC G08G 1/096844; G08G 1/096811; H04W 4/46; G01C 21/3492; G01C 21/3626

(57) ABSTRACT

An information presenting device predicts a travel route of a first manned driving vehicle and outputs a signal for displaying the travel route of the first manned driving vehicle to a display device mounted on a second manned driving vehicle.

### TECHNICAL FIELD

The present invention relates to an information presenting device, an information presenting method, and a manned driving vehicle.

Priority is claimed on Japanese Patent Application No. 2018-035242, filed on Feb. 28, 2018, the content of which is incorporated herein by reference.

### BACKGROUND ART

There is a plurality of manned driving vehicles such as loading vehicles and transport vehicles at the construction site. An operator of a manned driving vehicle needs to carefully observe the construction site and perform work while considering safety.

PTL 1 discloses a technique for measuring the positions of a work machine and a construction vehicle and outputting an alarm based on the degree of proximity. Further, PTL 2 discloses a technique for causing an alarm device to output an alarm, when a work machine enters a predetermined range.

### CITATION LIST

### Patent Literature

[PTL 1] Japanese Unexamined Patent Application, First Publication No. 2008-303648

[PTL 2] Japanese Unexamined Patent Application, First Publication No. 2012-203677

### DISCLOSURE OF INVENTION

### Technical Problem

Since there are buildings and fences at the construction site, there are many blind spots for operators of manned driving vehicles. Since another manned driving vehicle may exist in the blind spot, the operator needs to work while considering that another manned driving vehicle may appear from the blind spot. Further, according to the techniques described in PTLS 1 and 2, an alarm is output when another manned driving vehicle exists in the vicinity of a certain manned driving vehicle regardless of whether there is a blind spot. However, depending on the techniques described in PTLS 1 and 2, the operator cannot recognize how other manned driving vehicles existing in the blind spot move.

An object of the present invention is to provide an information presenting device, an information presenting method, and a manned driving vehicle which can make an operator of a manned driving vehicle easily recognize the movements of other manned driving vehicles.

### Solution to Problem

According to an aspect of the present invention, an information presenting device includes a route prediction unit that is configured to predict a travel route of a first manned driving vehicle; and a display control unit that is configured to output a signal for displaying the travel route of the first manned driving vehicle to a display device mounted on a second manned driving vehicle.

### Advantageous Effects of Invention

According to the above aspect, the information presenting device can make an operator of a manned driving vehicle recognize the movements of other manned driving vehicles easily.

### BRIEF DESCRIPTION OF DRAWINGS

FIG. 1 is a schematic diagram showing a configuration of a construction site management system according to a first embodiment.

FIG. 2 is a perspective view showing the configuration of the inside of a cab of a loading vehicle.

FIG. 3 is a schematic block diagram showing a configuration of an information presenting device according to the first embodiment.

FIG. 4 is a flowchart showing a method of generating an overall overhead image by the information presenting device according to the first embodiment.

FIG. 5 is the flowchart showing the method of generating an overall overhead image by the information presenting device according to the first embodiment.

FIG. 6 is an example of an image displayed on an in-vehicle terminal that is not associated with a vehicle captured in the overall overhead image.

FIG. 7 is an example of an image displayed on an in-vehicle terminal of a loading vehicle in which there is no transport vehicle in the vicinity.

FIG. 8 is an example of an image displayed on the in-vehicle terminal of a loading vehicle in which there is a transport vehicle in the vicinity.

FIG. 9 is a flowchart showing a method of designating a transport vehicle in the first embodiment.

FIG. 10 is a flowchart showing a method of designating a loading vehicle in the first embodiment.

FIG. 11 is a schematic block diagram showing a configuration of an information presenting device according to a second embodiment.

FIG. 12 is a flowchart showing a method of designating a transport vehicle in the second embodiment.

FIG. 13 is a schematic block diagram showing a configuration of an information presenting device according to a third embodiment.

### BEST MODE FOR CARRYING OUT THE INVENTION

### First Embodiment

### Construction Site Management System

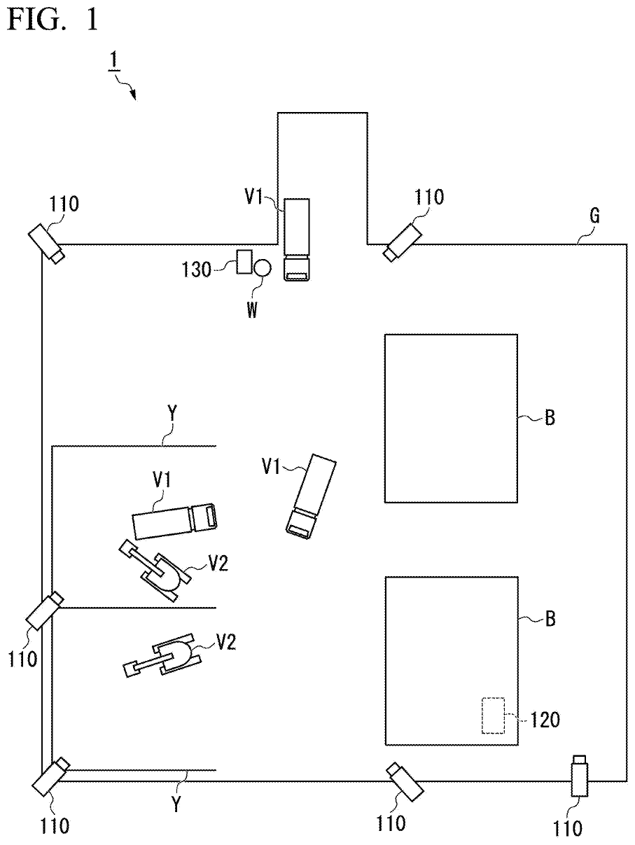

FIG. 1 is a schematic diagram showing a configuration of a construction site management system according to a first embodiment.

A construction site management system 1 is a system for alerting the operator of the loading vehicle V2 by presenting the travel route of the transport vehicle V1 to the in-vehicle terminal V203 (display device) of the loading vehicle V2 traveling on the construction site G. The loading vehicle V2 and the transport vehicle V1 are examples of manned driving vehicles. In particular, the transport vehicle V1 is an example of a first manned driving vehicle, and the loading vehicle V2 is an example of a second manned driving vehicle. The construction site management system 1 includes a plurality of imaging devices 110 and an information presenting device 120.

The plurality of imaging devices 110 are respectively installed above the construction site G and image an overhead view of the construction site G. The plurality of imaging devices 110 are provided such that all points in the construction site G where a manned driving vehicle can travel are captured by at least one imaging device 110.

The information presenting device 120 generates an overall overhead image in which the entire construction site G is captured, based on images captured by the plurality of imaging devices 110. Further, the information presenting device 120 displays the overall overhead image on which the travel route of the transport vehicle V1 is drawn, on the in-vehicle terminal V203 of the loading vehicle V2. The information presenting device 120 is provided in the building B of the construction site G, for example.

The construction site G shown in FIG. 1 is provided with two buildings B and two stockyards Y. The stockyard Y is a space for temporarily storing the earth generated by the construction work for reuse. In addition, in other embodiments, the structure of the construction site G is not restricted to the structure shown in FIG. 1. That is, the presence or absence and the number of buildings B and stockyards Y are not limited to those shown in FIG. 1.

In the construction site G shown in FIG. 1, the worker W checks the load of the transport vehicle V1 entering the construction site G at the entrance of the construction site G. The worker W determines the stockyard Y that is the destination of the transport vehicle V1 based on the type of the load and notifies the operator of the transport vehicle V1. Further, when there is no load of the transport vehicle V1, the worker W hears the load scheduled to be loaded from the operator of the transport vehicle V1 and determines a destination based on the heard load. The worker W has a worker terminal 130 such as a smartphone. The worker W inputs, to the worker terminal 130, the destination notified to the operator of the transport vehicle V1. The worker terminal 130 transmits the input destination to the information presenting device 120. The transport vehicle V1 exits the construction site G in an empty state after unloading the load to the stockyard Y, or exits after loading another load. In this case, the worker W may hear the work schedule after unloading the load and may also transmit information on the next destination to the information presenting device 120 through the worker terminal 130.

### Loading Vehicle

The loading vehicle V2 is a vehicle that operates at a site where earth is loaded and performs embankment work or excavation work. Examples of the loading vehicle V2 include a hydraulic excavator, a bulldozer, and a wheel loader.

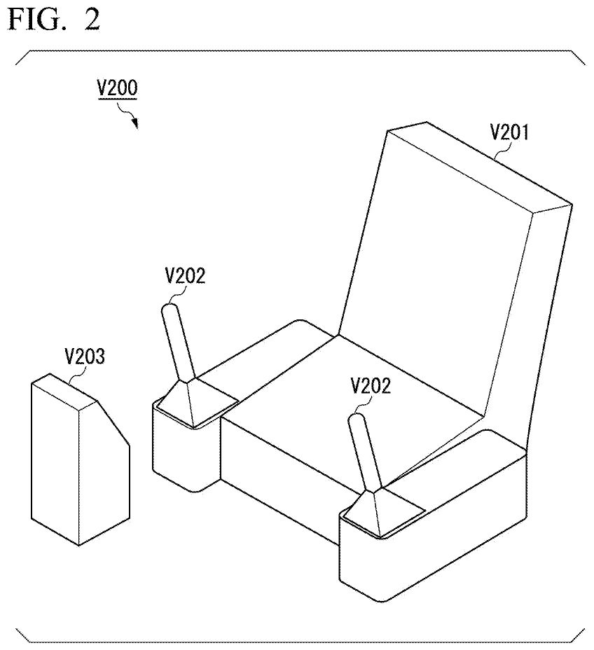

FIG. 2 is a perspective view showing the configuration of the inside of the cab of the loading vehicle. The loading vehicle V2 includes a cab V200. Inside the cab V200, an operator's seat V201 for an operator to sit, an operation device V202 for operating the loading vehicle V2, and an in-vehicle terminal V203 for displaying information related to work are provided.

The operation device V202 generates operation signals for the operation of the work equipment, the turning operation, and the traveling operation of the loading vehicle V2 according to the operation of the operator. The in-vehicle terminal V203 is provided between the windshield of the cab V200 and the operator's seat V201. Note that, the position of the in-vehicle terminal V203 is not limited to the position shown in FIG. 2.

### Information Presenting Device

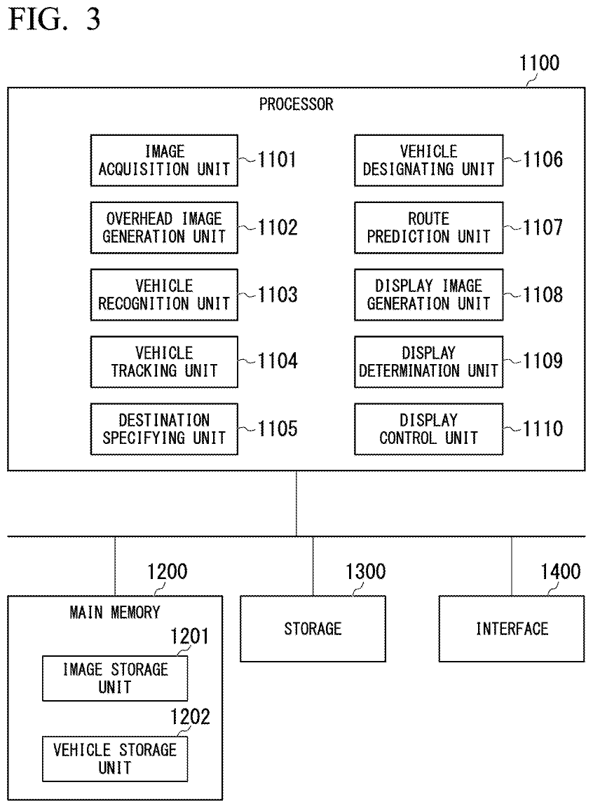

FIG. 3 is a schematic block diagram showing a configuration of an information presenting device according to a first embodiment.

The information presenting device 120 is a computer including a processor 1100, a main memory 1200, a storage 1300, and an interface 1400. The storage 1300 stores a program. The processor 1100 reads the program from the storage 1300, loads it in the main memory 1200, and executes the processing according to the program.

Examples of the storage 1300 include a HDD, an SSD, a magnetic disk, a magneto-optical disk, a CD-ROM, and a DVD-ROM. The storage 1300 may be an internal medium directly connected to the common communication line of the information presenting device 120 or an external medium connected to the information presenting device 120 through the interface 1400. The storage 1300 is a tangible storage medium that is not temporary.

By executing a program, the processor 1100 includes an image acquisition unit 1101, an overhead image generation unit 1102, a vehicle recognition unit 1103, a vehicle tracking unit 1104, a destination specifying unit 1105, a vehicle designating unit 1106, a route prediction unit 1107, a display image generation unit 1108, a display determination unit 1109, and a display control unit 1110.

Further, the processor 1100 reserves storage areas of the image storage unit 1201 and the vehicle storage unit 1202 in the main memory 1200 by executing the program.

The image acquisition unit 1101 acquires images from each of the plurality of imaging devices 110 every predetermined time.

The overhead image generation unit 1102 deforms and combines a plurality of images acquired by the image acquisition unit 1101, thereby generating an overall overhead image showing the entire construction site G. The overhead image generation unit 1102 stores in advance the deformation parameters of the image captured by the imaging device 110 for each imaging device 110. The deformation parameters of the image can be specified based on the installation position and the line-of-sight direction of the imaging device 110. Note that, the method for generating the overhead image is not limited to this. For example, the overhead image generation unit 1102 according to another embodiment may generate a three-dimensional image of the construction site G by performing triangulation on the plurality of images acquired by the image acquisition unit 1101 and generate overall overhead image based on the acquired three-dimensional image.

The vehicle recognition unit 1103 extracts a location where the vehicle is captured, from the overall overhead image generated by the overhead image generation unit 1102. The vehicle recognition unit 1103 can extract a location where the vehicle is captured, by pattern matching based on the known feature value of a vehicle image, for example.

The vehicle tracking unit 1104 specifies coordinates where the same vehicle as the vehicle recognized in the past image is located, from the image acquired by the image acquisition unit 1101. The vehicle tracking unit 1104 can track the vehicle by, for example, searching for an image similar to a vehicle recognized in the past, from the image acquired by the image acquisition unit 1101.

The vehicle designating unit 1106 receives the designation of one vehicle from one or more vehicles recognized by the vehicle recognition unit 1103. For example, the vehicle designating unit 1106 receives the information indicating the coordinates from the in-vehicle terminal V203 or a computer operated by the administrator and considers that the loading vehicle V2 captured in the coordinates designated in the overall overhead image or in the vicinity thereof is designated. Further, for example, when the vehicle designating unit 1106 receives information indicating the destination from the worker terminal 130, the vehicle designating unit 1106 considers that the transport vehicle V1 captured in the position corresponding to the entrance of the construction site G in the overall overhead image is designated.

Based on the information indicating the destination of the transport vehicle V1 received from the worker terminal 130, the destination specifying unit 1105 specifies the destination of the transport vehicle V1 that the vehicle designating unit 1106 has accepted the designation.

The route prediction unit 1107 predicts a travel route connecting the position of the transport vehicle V1 and the destination, based on the destination specified by the destination specifying unit 1105 and the position of the transport vehicle V1. For example, the route prediction unit 1107 stores in advance an area where the vehicle can travel in the construction site G and predicts a travel route by calculating a route to reach the destination in the shortest in the area.

The display image generation unit 1108 generates a display image to be displayed on the in-vehicle terminal V203 of the loading vehicle V2, based on the overall overhead image stored in the image storage unit 1201 and the information stored in the vehicle storage unit 1202.

The display determination unit 1109 determines whether or not to display the travel route of the transport vehicle V1 on the loading vehicle V2, based on the distance between the transport vehicle V1 and the loading vehicle V2. The display determination unit 1109 determines to display the travel route of the transport vehicle V1 on the loading vehicle V2, in a case where the distance between the transport vehicle V1 and the loading vehicle V2 is equal to or less than a predetermined threshold.

The display control unit 1110 transmits the display image generated by the display image generation unit 1108 to the loading vehicle V2.

The image storage unit 1201 stores the overall overhead image in time series.

The vehicle storage unit 1202 stores, for each vehicle recognized by the vehicle recognition unit 1103, identification information, a type, and a position representing the vehicle. The vehicle identification information is given every time the vehicle recognition unit 1103 recognizes a new vehicle, and is a value for identifying the vehicle in the tracking process by the vehicle tracking unit 1104. The identification information is different from actual identification information (machine number, IP address, or the like) for specifying the actual vehicle. Examples of vehicle types include the loading vehicles V2, the transport vehicles V1, and other vehicles. In a case where the vehicle is the loading vehicle V2, the vehicle storage unit 1202 further associates and stores the actual identification information of the loading vehicle V2. Further, in a case where the vehicle is the transport vehicle V1, the vehicle storage unit 1202 further associates and stores a destination (and a next destination).

### Presenting Method of Display Information

Next, the operation of the information presenting device 120 according to the first embodiment will be described.

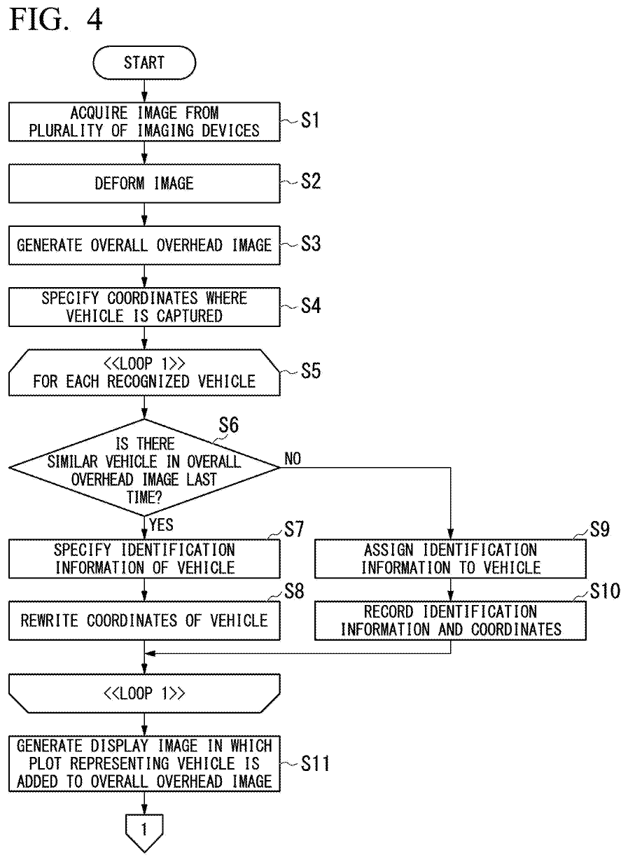

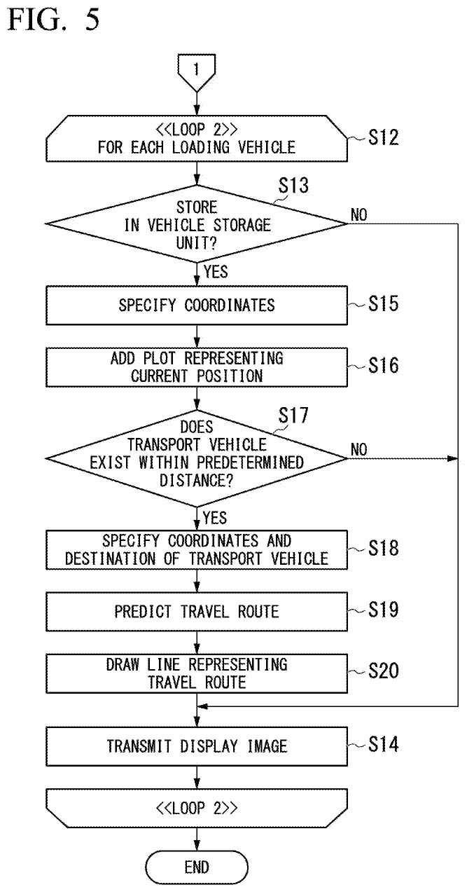

FIGS. 4 and 5 are flowcharts showing a method of generating an overall overhead image by the information presenting device according to the first embodiment.

The image acquisition unit 1101 of the information presenting device 120 acquires each image from each of the plurality of imaging devices 110 (step S1). The overhead image generation unit 1102 deforms each image acquired by the image acquisition unit 1101 using the deformation parameters corresponding to the installation position and the line-of-sight direction of the imaging device 110 (step S2). Next, the overhead image generation unit 1102 generates an overall overhead image by combining a plurality of deformed images, and stores the overall overhead image in the image storage unit 1201 (step S3). The vehicle recognition unit 1103 specifies coordinates where the loading vehicle V2 is captured and coordinates where the transport vehicle V1 is captured, from the generated overall overhead image (step S4).

The information presenting device 120 selects the vehicles recognized by the vehicle recognition unit 1103 one by one, and executes the following processing from step S6 to step S10 (step S5).

The vehicle tracking unit 1104 reads out the overall overhead image generated last time, from the image storage unit 1201, and determines whether or not a vehicle similar to the selected vehicle exists in the vicinity of the coordinates specified in step S4 (step S6). In a case where a vehicle similar to the selected vehicle exists in the vicinity of the specified coordinates (step S6: YES), the vehicle tracking unit 1104 specifies the identification information of the vehicle associated with the coordinates from the vehicle storage unit 1202 (step S7). The vehicle tracking unit 1104 rewrites the coordinates that the vehicle storage unit 1202 stores in association with the identification information to the coordinates specified in step S4 (step S8). On the other hand, in a case where a vehicle similar to the selected vehicle does not exist in the vicinity of the coordinates specified in step S4 (step S6: NO), the vehicle recognition unit 1103 assigns new identification information to the vehicle (step S9). The vehicle recognition unit 1103 associates the identification information with the coordinates specified in step S4 and records them in the vehicle storage unit 1202 (step S10).

Thus, the information presenting device 120 can update the positions of all the vehicles stored in the image storage unit 1201.

The display image generation unit 1108 generates a display image in which the plot P1 representing the vehicle is added to the coordinates specified in step S4 of the overall overhead image generated in step S3 (step S11). The display image generation unit 1108 may change the color and shape of the plot P1 depending on the type of vehicle and the like.

Next, the information presenting device 120 selects the loading vehicles V2 that exist on the construction site G one by one, and executes the following processing from step S13 to step S20 (step S12).

The display control unit 1110 determines whether there is a vehicle associated with the actual identification information of the selected loading vehicle V2 among the vehicles stored in the vehicle storage unit 1202 (step S13). In a case where the vehicle associated with the actual identification information of the selected loading vehicle V2 is not stored in the vehicle storage unit 1202 (step S13: NO), the display control unit 1110 transmits the display image generated in step S11 to the selected loading vehicle V2 (step S14).

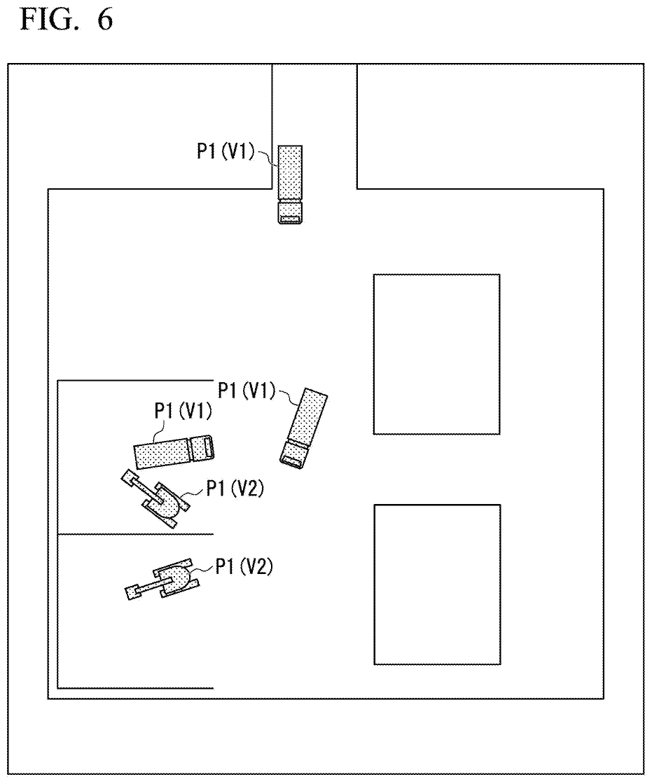

That is, as shown in FIG. 6, a display image including the overall overhead image and the plot P1 representing the vehicle is transmitted to a vehicle not associated with the vehicle captured in the overall overhead image, among the loading vehicles V2 present at the construction site G. FIG. 6 is an example of an image displayed on an in-vehicle terminal that is not associated with a vehicle captured in the overall overhead image.

On the other hand, in a case where the vehicle associated with the actual identification information of the selected loading vehicle V2 is stored in the vehicle storage unit 1202 (step S13: YES), the display image generation unit 1108 specifies the coordinates stored in the vehicle storage unit 1202 in association with the actual identification information of the selected loading vehicle V2 (step S15). Next, the display image generation unit 1108 attaches a plot P2 representing the current position to the coordinates specified in step S15 of the display image generated in step S11 (step S16). The plot P2 representing the current position differs from the plot P1 representing the vehicle attached in step S11 in at least one of color and shape.

Next, the display determination unit 1109 refers to the vehicle storage unit 1202 and determines whether or not the transport vehicle V1 exists within a predetermined distance from the coordinates specified in step S15 (step S17). In a case where the transport vehicle V1 does not exist within the predetermined distance from the coordinates of the selected loading vehicle V2 (step S17: NO), the display determination unit 1109 determines that there is no need to display the travel route on the in-vehicle terminal V203 of the selected loading vehicle V2. The display control unit 1110 transmits the display image generated in step S16 to the selected loading vehicle V2 (step S14).

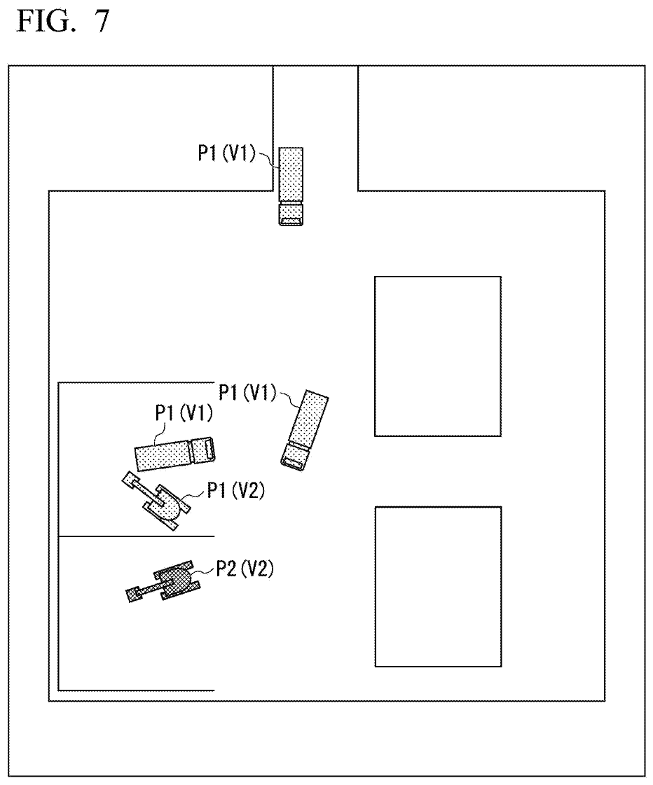

That is, as shown in FIG. 7, a display image including the overall overhead image, the plot P1 representing the vehicle, and a plot P2 representing the current position is transmitted to a vehicle which is associated with the vehicle captured in the overall overhead image and the transport vehicle V1 does not exist in the vicinity, among the loading vehicles V2 present at the construction site G. FIG. 7 is an example of an image displayed on an in-vehicle terminal of a loading vehicle in which there is no transport vehicle in the vicinity. Thus, the operator of the transport vehicle V1 can easily recognize the positional relationship between the loading vehicle V2 on board and other vehicles.

On the other hand, in a case where the transport vehicle V1 exists within the predetermined distance from the coordinates of the selected loading vehicle V2 (step S17: YES), the display determination unit 1109 determines that there is a need to display the travel route on the in-vehicle terminal V203 of the selected loading vehicle V2. The route prediction unit 1107 refers to the vehicle storage unit 1202 and specifies the coordinates and the destination of the transport vehicle V1 existing within a predetermined distance from the coordinates of the loading vehicle V2 (step S18). In a case where the transport vehicle V1 has already reached the destination and the next destination of the transport vehicle V1 is stored in the vehicle storage unit 1202, the next destination is specified. The route prediction unit 1107 predicts the travel route of the transport vehicle V1, based on the specified coordinates and destination (step S19). The display image generation unit 1108 draws a line L representing the travel route on the display image generated in step S16 (step S20). The display control unit 1110 transmits the display image generated in step S21 to the selected loading vehicle V2 (step S14).

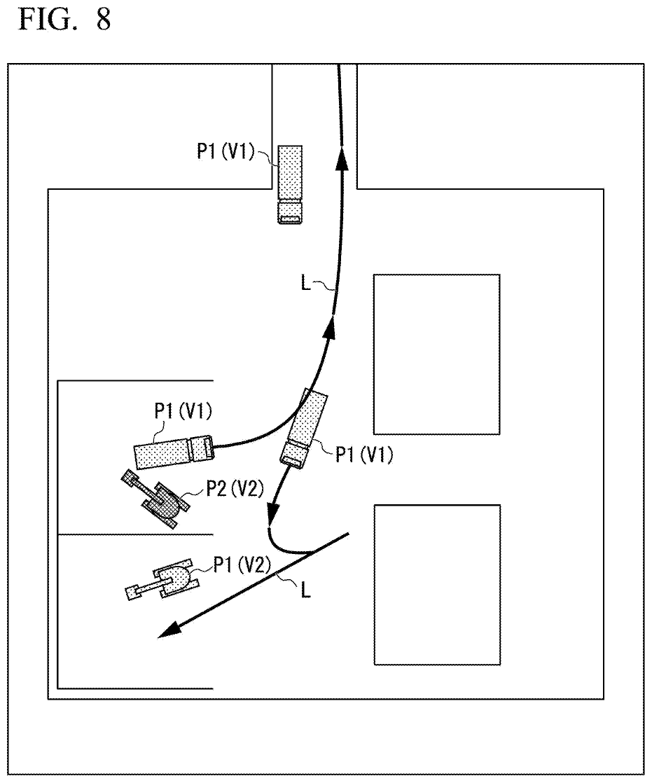

That is, as shown in FIG. 8, a display image including the overall overhead image, the plot P1 representing the vehicle, a plot P2 representing the current position, and a line L representing the travel route of the nearby transport vehicle V1 is transmitted to a vehicle which is associated with the vehicle captured in the overall overhead image and the transport vehicle V1 exists in the vicinity, among the loading vehicles V2 present at the construction site G. FIG. 8 is an example of an image displayed on the in-vehicle terminal of a loading vehicle in which there is a transport vehicle in the vicinity. Thus, the operator of the transport vehicle V1 can easily recognize the movement of the transport vehicle V1 in the vicinity of the loading vehicle V2 on board.

### Designation Method of Transport Vehicle

Next, a method of designating the transport vehicle V1 and registering the destination in the information presenting device 120 will be described.

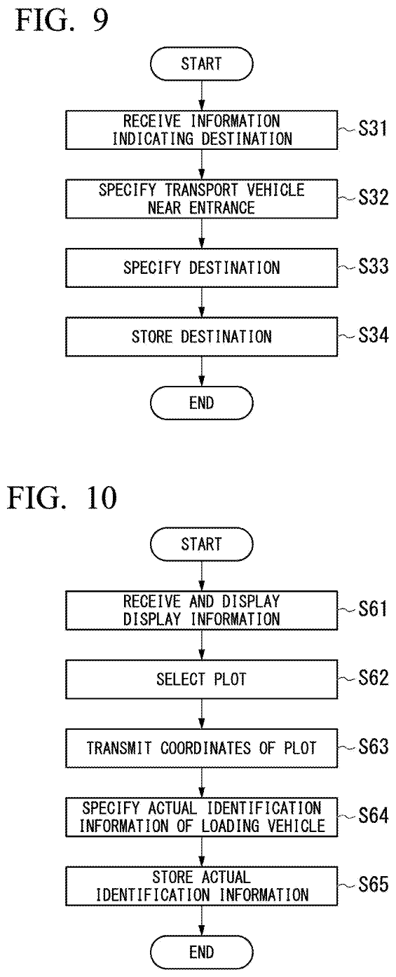

FIG. 9 is a flowchart showing a method of designating a transport vehicle in the first embodiment.

When the transport vehicle V1 arrives at the entrance of the construction site G, the worker W recognizes the load of the transport vehicle V1 and determines the destination stockyard based on this. When the worker transmits the determined stockyard location to the transport vehicle V1, the worker inputs the stockyard location to the worker terminal 130 as a destination. The worker terminal 130 transmits the input destination to the information presenting device 120.

The vehicle designating unit 1106 of the information presenting device 120 receives information indicating the destination from the worker terminal 130 (step S31). The vehicle designating unit 1106 specifies a vehicle whose coordinates are the closest to the entrance of the construction site G, among the transport vehicles V1 stored in the vehicle storage unit 1202 (step S32). Next, the destination specifying unit 1105 specifies the destination of the transport vehicle V1 specified in step S32, based on the received information (step S33). The vehicle designating unit 1106 stores the vehicle specified in step S32 in association with the specified destination in the vehicle storage unit 1202 (step S34). That is, the vehicle designating unit 1106 receives the designation of the transport vehicle V1 by receiving information representing the destination from the worker terminal 130.

### Designation Method of Loading Vehicle

Next, a method of designating the loading vehicle V2 from the overall overhead image will be described. FIG. 10 is a flowchart showing a method of designating a loading vehicle in the first embodiment.

When the operator of the loading vehicle V2 activates the loading vehicle V2, the in-vehicle terminal V203 is also activated. When the in-vehicle terminal V203 is activated, it receives and displays a display image from the information presenting device 120 (step S61). Since the loading vehicle V2 that has been activated is not associated with the vehicle captured in the overall overhead image in the information presenting device 120, the display image that is displayed at this time does not include the plot P2 representing the current position.

The operator operates the in-vehicle terminal V203, searches for the loading vehicle V2 on board from the display image, and selects the plot P1 representing the loading vehicle V2 (step S62). The in-vehicle terminal V203 specifies the coordinates of the selected plot P1 and transmits the coordinates to the information presenting device 120 (step S63).

When receiving the information indicating the coordinates of the plot P1 from the in-vehicle terminal V203, the vehicle designating unit 1106 of the information presenting device 120 specifies the actual identification information of the loading vehicle V2 including the in-vehicle terminal V203 that is the transmission source of the information (step S64). Then, the vehicle designating unit 1106 stores the specified actual identification information in the vehicle storage unit 1202 in association with the vehicle related to the received coordinates (step S65). That is, the vehicle designating unit 1106 receives the designation of the transport vehicle V1 by receiving the information indicating the coordinates of the plot P1 from the in-vehicle terminal V203.

Thus, since the loading vehicle V2 captured in the overall overhead image and the actual identification information are associated with each other, a display image including the plot P2 representing the current position is transmitted to the loading vehicle V2.

### Action and Effect

As described above, according to the first embodiment, the information presenting device 120 predicts the travel route of the transport vehicle V1 and outputs a display image displaying the travel route of the transport vehicle V1 to the in-vehicle terminal V203 mounted on the loading vehicle V2. Thereby, the operator of the loading vehicle V2 can recognize the movement of the transport vehicle V1 easily.

Further, according to the first embodiment, the information presenting device 120 outputs a display image displaying the travel route of the transport vehicle V1, in a case where the distance between the transport vehicle V1 and the loading vehicle V2 is less than a predetermined distance. Thus, the operator of the loading vehicle V2 can easily recognize the movement of the transport vehicle V1 in the vicinity of the loading vehicle V2 in which the operator is on board. On the other hand, in other embodiments, the information presenting device 120 may output a display image that displays the travel route of the transport vehicle V1 regardless of the distance between the transport vehicle V1 and the loading vehicle V2.

Further, according to the first embodiment, the information presenting device 120 predicts the travel route for the transport vehicle V1 which approached the entrance of the construction site G. That is, the information presenting device 120 outputs a display image that displays the travel route, in a case where the transport vehicle V1 is present at the same construction site G as the loading vehicle V2. Thus, the in-vehicle terminal V203 can display the travel route of the transport vehicle V1 having the possibility of contact. On the other hand, in other embodiments, the information presenting device 120 may also display the travel route of the transport vehicle V1 that is away from the construction site G.

Further, the information presenting device 120 according to the first embodiment displays the travel route of the transport vehicle V1 on the in-vehicle terminal V203 of the loading vehicle V2. This is because the traveling speed of the transport vehicle V1 is higher than the travel speed of the loading vehicle V2, and thus the operator of the loading vehicle V2 needs to pay particular attention to the movement of the transport vehicle V1. On the other hand, in other embodiments, not only the transport vehicle V1 but also the travel route of the other loading vehicle V2 may be displayed on the in-vehicle terminal V203 of the loading vehicle V2.

Further, the travel route may be displayed on a vehicle other than the loading vehicle V2.

### Second Embodiment

In the construction site management system 1 according to the first embodiment, the worker W determines a destination from the load of the transport vehicle V1. On the other hand, in the construction site management system 1 according to a second embodiment, the information presenting device 120 specifies a destination, based on the image captured by the imaging device 110.

### Information Presenting Device

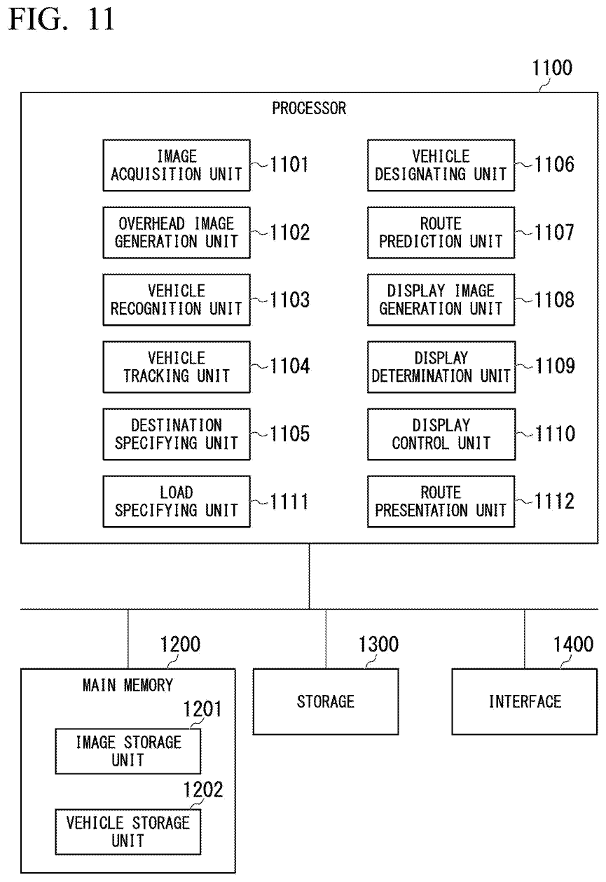

FIG. 11 is a schematic block diagram showing a configuration of an information presenting device according to a second embodiment.

An information presenting device 120 according to the second embodiment further includes a load specifying unit 1111 and a route presentation unit 1112 in addition to the configuration of the first embodiment. For example, the load specifying unit 1111 specifies the load of the transport vehicle V1 by pattern matching or the like of the overall overhead image. The route presentation unit 1112 displays the destination specified by the destination specifying unit 1105 on the worker terminal 130.

### Designation Method of Transport Vehicle

A method of designating the transport vehicle V1 in the construction site management system 1 according to the second embodiment will be described.

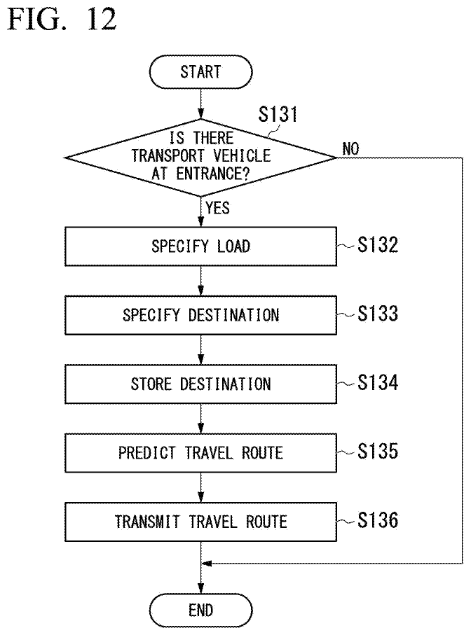

FIG. 12 is a flowchart showing a method of designating a transport vehicle in the second embodiment.

The vehicle designating unit 1106 of the information presenting device 120 determines whether or not the transport vehicle V1 is captured in the area where the entrance of the construction site G is captured among the overall overhead image (step S131). In a case where the transport vehicle V1 is not captured in the area where the entrance of the construction site G is captured (step 5131: NO), there is no transport vehicle to be designated, so the process ends. On the other hand, in a case where the transport vehicle V1 is captured in the area where the entrance of the construction site G is captured (step 5131: YES), the load specifying unit 1111 specifies an area where the vessel of the transport vehicle V1 is captured, in the area where the entrance of the construction site G is captured, among the overall overhead image, and specifies the type of load by processing such as pattern matching (step S132).

Next, the destination specifying unit 1105 specifies the destination of the transport vehicle V1, based on the load specified by the load specifying unit 1111 (step S133). For example, the destination specifying unit 1105 stores a table in which the type of the load and the destination are associated with each other, and determines the destination based on the load specified by the load specifying unit 1111 and the table. The vehicle designating unit 1106 stores the vehicle specified in step S132 in association with the specified destination in the vehicle storage unit 1202 (step S134).

That is, the information presenting device 120 according to the second embodiment can automatically specify the destination of the transport vehicle V1 without receiving the designation of the transport vehicle V1 from the worker terminal 130.

The route prediction unit 1107 predicts a travel route, based on the position of the transport vehicle V1 and the specified destination (step S135). Then, the route presentation unit 1112 transmits a display signal for displaying the predicted travel route on the worker terminal 130 (step S136). Thus, the travel route is displayed on the worker terminal 130. The worker W can present the recommended travel route to the operator by presenting the worker terminal 130 to the operator of the transport vehicle V1 that has entered the entrance.

In the second embodiment, the information presenting device 120 presents the travel route to the operator of the transport vehicle V1 through the worker terminal 130, but the present invention is not limited thereto. For example, in other embodiments, the information presenting device 120 may display the travel route on a portable terminal held by the operator of the transport vehicle V1 or an in-vehicle terminal mounted on the transport vehicle V1. in other embodiments, the information presenting device 120 may not present the travel route to the operator of the transport vehicle V1.

### Third Embodiment

The information presenting device 120 according to the first and second embodiments predicts a travel route by calculating a route to reach the destination in the shortest in an area where the vehicle can travel in the construction site G in advance. On the other hand, the information presenting device 120 according to the third embodiment predicts the travel route of each transport vehicle V1, based on the travel history of the transport vehicle V1.

### Information Presenting Device

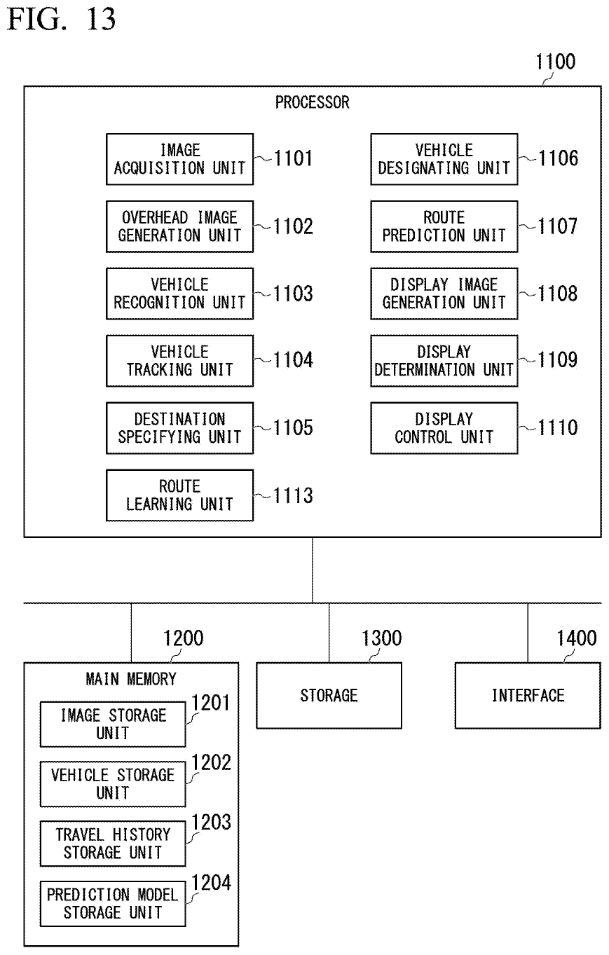

FIG. 13 is a schematic block diagram showing a configuration of an information presenting device according to a third embodiment.

The information presenting device 120 according to the third embodiment further includes a travel history storage unit 1203, a prediction model storage unit 1204, and a route learning unit 1113 in addition to the configuration of the first embodiment.

The travel history storage unit 1203 stores, for each transport vehicle V1, time series of positions until the transport vehicle V1 that has entered the construction site G arrives at the stockyard Y, and time series of positions until the transport vehicle V1 exits from the construction site G after leaving the stockyard Y. The prediction model storage unit 1204 stores a machine learning model for outputting a travel route, with the identification information of the transport vehicle V1 and the destination as an input. Examples of machine learning models include neural network models and hidden Markov models.

The route learning unit 1113 updates the machine learning model stored in the prediction model storage unit 1204, based on the training data in which the identification information of the transport vehicle V1, the destination of the transport vehicle V1, and the time series of the positions representing the travel of the transport vehicle V1 at that time are associated with each other. The training data is generated from the identification information of the vehicle designated by the vehicle designating unit 1106, the destination specified by the destination specifying unit 1105, and the information stored in the travel history storage unit 1203.

The route prediction unit 1107 can obtain the output of the travel route by inputting the identification information of the vehicle designated by the vehicle designating unit 1106 and the destination specified by the destination specifying unit 1105 to the machine learning model stored in the prediction model storage unit 1204.

In this way, according to the third embodiment, the information presenting device 120 predicts the travel route of the transport vehicle V1, based on the information related to the travel history of the transport vehicle V1 like a machine learning model. Thus, the information presenting device 120 can predict a travel route, based on the individuality of the operator of the transport vehicle V1.

In addition, in other embodiments, the information presenting device 120 may not necessarily perform machine learning. For example, the information presenting device 120 according to other embodiments may output as the travel route, a route where that the transport vehicle V1 has traveled in the past toward the same destination.

### Other Embodiments

As described above, although an embodiment has been described in detail with reference to drawings, a concrete configuration is not limited to the above description, and various design changes or the like are possible.

For example, the construction site management system 1 according to the above-described embodiments generates a display image including an overall overhead image obtained by combining images captured by the plurality of imaging devices 110, but the present invention is not limited thereto. For example, the information presenting device 120 according to another embodiment may generate a display image including a CAD image in which the entire construction site G is captured, instead of the overall overhead image. Even in this case, the information presenting device 120 generates a plot P1 representing the vehicle and a plot P2 representing the current position, based on the overall overhead image or the image captured by each imaging device 110.

Further, in other embodiments, the in-vehicle terminal V203 may combine and display the travel route of the transport vehicle V1 on the image captured by the imaging device mounted on the loading vehicle V2.

In addition, the construction site management system 1 according to the above-described embodiments associates the transport vehicle V1 with the destination by specifying the transport vehicle V1 present near the entrance of the construction site G when receiving information indicating the destination from the worker terminal 130, but the present invention is not limited thereto. For example, the construction site management system 1 according to another embodiment may specify a vehicle to be emphasized based on position information specified by the GNSS mounted on the transport vehicle V1, or may associate the transport vehicle V1 with the destination by recognizing a unique identification mark attached to the transport vehicle V1 from the image captured by the imaging device 110.

Note that, the construction site management system 1 according to the above-described embodiments generates an overhead image and recognition of a vehicle by the information presenting device 120 provided in the construction site G, but the present invention is not limited thereto. For example, in the construction site management system 1 according to other embodiments, each in-vehicle terminal V203 of each loading vehicle V2 may function as the information presenting device 120. In this case, the in-vehicle terminal V203 can display the travel route of the transport vehicle V1 as follows, for example. The in-vehicle terminal V203 of each loading vehicle V2 can receive images captured by the plurality of imaging devices 110, generate an overhead image of the construction site G based on the plurality of received images, and specify the position of the vehicle. That is, in the present embodiment, the in-vehicle terminal V203 specifies the positions of the plurality of vehicles, based on the images captured by the plurality of imaging devices 110. Then, the in-vehicle terminal V203 displays on the screen the travel route of the transport vehicle V1 indicating the position of another vehicle that is close to the loading vehicle V2. That is, in other embodiments, the information presenting device 120 is not necessarily implemented as a server, and may be implemented by, for example, a plurality of in-vehicle terminals V203 that perform communication to each other.

### INDUSTRIAL APPLICABILITY

The information presenting device according to the present invention can make an operator of a manned driving vehicle easily recognize the movements of other manned driving vehicles.

### REFERENCE SIGNS LIST

1 construction site management system
110 imaging device
120 information presenting device
1101 image acquisition unit
1102 overhead image generation unit
1103 vehicle recognition unit
1104 vehicle tracking unit
1105 destination specifying unit
1106 vehicle designating unit
1107 route prediction unit
1108 display image generation unit
1109 display determination unit
1110 display control unit
1111 load specifying unit
1112 route presentation unit
1113 route learning unit
1201 image storage unit
1202 vehicle storage unit
1203 travel history storage unit
1204 prediction model storage unit
130 worker terminal
V1 transport vehicle
V2 loading vehicle
V203 in-vehicle terminal

1. An information presenting device comprising:
a route prediction unit that is configured to predict a travel route of a first manned driving vehicle; and
a display control unit that is configured to output a signal for displaying the travel route of the first manned driving vehicle to a display device mounted on a second manned driving vehicle.

2. The information presenting device according to claim 1,
wherein the first manned driving vehicle is a transport vehicle, and
wherein the second manned driving vehicle is a loading vehicle.

3. The information presenting device according to claim 1,
wherein the display control unit outputs the signal for displaying the travel route, in a case where a distance between the first manned driving vehicle and the second manned driving vehicle becomes less than a predetermined distance.

4. The information presenting device according to claim 1,
wherein the display control unit outputs the signal for displaying the travel route, in a case where the first manned driving vehicle is present at the same construction site as the second manned driving vehicle.

5. The information presenting device according to claim 1, further comprising:
a destination specifying unit that is configured to specify a destination of the first manned driving vehicle,
wherein the route prediction unit predicts the travel route, based on a position of the first manned driving vehicle and the destination.

6. The information presenting device according to claim 5, further comprising:
a load specifying unit that is configured to specify a load of the first manned driving vehicle,
wherein the destination specifying unit specifies the destination based on the load.

7. The information presenting device according to claim 1, further comprising:
a history storage unit that is configured to store information related to a travel history for each of a plurality of the first manned driving vehicles,
wherein the route prediction unit predicts the travel route of the first manned driving vehicle based on the information stored in the history storage unit.

8. The information presenting device according to claim 1, further comprising:
a route presentation unit that is configured to present a travel route that the first manned driving vehicle is to travel, to an operator of the first manned driving vehicle.

9. An information presenting method comprising the steps of:
predicting a travel route of a first manned driving vehicle; and
outputting a signal for displaying the travel route of the first manned driving vehicle to a display device mounted on a second manned driving vehicle.

10. A manned driving vehicle comprising:
a display device that is configured to display a travel route of another manned driving vehicle.

11. The information presenting device according to claim 2,
wherein the display control unit outputs the signal for displaying the travel route, in a case where a distance between the first manned driving vehicle and the second manned driving vehicle becomes less than a predetermined distance.

12. The information presenting device according to claim 2,
wherein the display control unit outputs the signal for displaying the travel route, in a case where the first manned driving vehicle is present at the same construction site as the second manned driving vehicle.

13. The information presenting device according to claim 3,
wherein the display control unit outputs the signal for displaying the travel route, in a case where the first manned driving vehicle is present at the same construction site as the second manned driving vehicle.

14. The information presenting device according to claim 2, further comprising:
a destination specifying unit that is configured to specify a destination of the first manned driving vehicle,
wherein the route prediction unit predicts the travel route, based on a position of the first manned driving vehicle and the destination.

15. The information presenting device according to claim 3, further comprising:
a destination specifying unit that is configured to specify a destination of the first manned driving vehicle,
wherein the route prediction unit predicts the travel route, based on a position of the first manned driving vehicle and the destination.

16. The information presenting device according to claim 14, further comprising:
a load specifying unit that is configured to specify a load of the first manned driving vehicle,
wherein the destination specifying unit specifies the destination based on the load.

17. The information presenting device according to claim 2, further comprising:
a history storage unit that is configured to store information related to a travel history for each of a plurality of the first manned driving vehicles,
wherein the route prediction unit predicts the travel route of the first manned driving vehicle based on the information stored in the history storage unit.

18. The information presenting device according to claim 3, further comprising:
a history storage unit that is configured to store information related to a travel history for each of a plurality of the first manned driving vehicles,
wherein the route prediction unit predicts the travel route of the first manned driving vehicle based on the information stored in the history storage unit.

19. The information presenting device according to claim 2, further comprising:
a route presentation unit that is configured to present a travel route that the first manned driving vehicle is to travel, to an operator of the first manned driving vehicle.

20. The information presenting device according to claim 3, further comprising:
a route presentation unit that is configured to present a travel route that the first manned driving vehicle is to travel, to an operator of the first manned driving vehicle.
